(19) United States
(12) Patent Application Publication
(10) Pub. No.: US 2011/0070919 A1
(43) Pub. Date: Mar. 24, 2011

(54) TRANSMISSION POWER CONTROL APPARATUS, TRANSMISSION POWER CONTROL METHOD, AND COMPUTER-READABLE STORAGE MEDIUM STORING TRANSMISSION POWER CONTROL PROGRAM

(76) Inventors: Toshihiko KOMINE, Fujimino-shi (JP); Takeo Ohseki, Fujimino-shi (JP); Satoshi Konishi, Fujimino-shi (JP)

(21) Appl. No.: 12/878,475

(22) Filed: Sep. 9, 2010

(30) Foreign Application Priority Data
Sep. 18, 2009 (JP) 2009-216975

(51) Int. Cl. H04B 7/00

(52) U.S. Cl. 455/522

(57) ABSTRACT

A transmission power control apparatus is provided with: an interference information acquisition unit which acquires interference information indicative of an interference amount for each frequency block in a neighboring base station; and a transmission power control unit which control the transmission power of a mobile terminal when a frequency block group configured by one or more frequency blocks is allocated to the mobile terminal, based on the interference information acquired by the interference information acquisition unit.

### BACKGROUND OF THE INVENTION

1. Field of the Invention

The present invention relates to a transmission power control apparatus, a transmission power control method, and a computer-readable storage medium storing a transmission power control program.

Priority is claimed on Japanese Patent Application No. 2009-216975, filed Sep. 18, 2009, the content of which is incorporated herein by reference.

2. Description of the Related Art

In accordance with the LTE (Long Term Evolution), base stations can communicate information on interference (interference information) and information on allocation, such as an OI (Overload Indicator) or an HII (High Interference Indicator), with one another by way of a backbone network. Cooperative operations between base stations can be realized based on these pieces of information. As an OI, each sector notifies neighboring sectors of interference information for each frequency block which is measured by each sector. A frequency block is the minimum allocation unit of radio resources which is configured by a contiguous band. Interference information is represented by one of three levels including 0, 1, and 2. The larger the level of interference, the larger the value set in interference information.

Transmission power control using interference information acquired from neighboring sectors is being studied (see Japanese Unexamined Patent Application, First Publication No. 2008-092545 (hereinafter referred to as “Patent Document 1”) and 3GPP2 C.S0084-002-0, “Medium Access Control Layer For Ultra Mobile Broadband (UMB) Air Interface Specification” (hereinafter referred to as “Non-Patent Document 1”)). Patent Document 1 and Non-Patent Document 1 disclose a scheme for determining the transmission power of a mobile terminal (a terminal) in an uplink from the mobile terminal to a base station. This scheme is in compliance with the standard specifications of a cellular system called the “Medium Access Control Layer for Ultra Mobile Broadband (UMB)”.

In Patent Document 1, a determination is made whether to increase (raise), decrease (drop), or maintain the transmission power based on a plurality of pieces of interference information in the entire band which are calculated with respect to a sector that a path loss (attenuation) between this sector and a mobile terminal is the minimum among path losses relevant to the sectors other than a sector (hereinafter referred to as “a connecting sector”) to which the mobile terminal is connecting. The fundamental operation of a transmission power control unit for controlling the transmission power is controlled based on a policy that the transmission power is decreased or maintained (i.e., not changed) if interference is large and the transmission power is increased or maintained if interference is small. Whether to decrease or maintain the transmission power as well as whether to increase or maintain the transmission power are determined using probability. The probability is obtained from the current power level and the difference between a path loss relevant to a connecting sector and the minimum path loss among path losses relevant to the sectors other than the connecting sector.

In Non-Patent Document 1, interference information is represented by one of three levels including 0, 1, and 2 as an IoT (Interference over Thermal) level.

Specifically, whether the transmission power is to be increased, decreased, or maintained is determined by Expression (1) shown below. That is, whether to increase, decrease, or maintain the transmission power is determined using a DecisionThreshold and an IoTLevel. In accordance with Expression (1), the transmission power is increased if P(i)=1, the transmission power is decreased if P(i)=−1, and the transmission power is maintained if P(i)=0.

$$P ( i ) = \{ \begin{matrix}1 & x \leq DecisionThreshold and IoTLevel = 0 \\ - 1 & x \leq DecisionThreshold and IoTLevel = 1 or 2 \\ 0 & otherwise\end{matrix} \qquad ( 1 )$$

where x is a uniform random number in the range from 0 to 1, and i is the current time (i.e., the time at which power control is about to be performed).

The DecisionThreshold in Expression (1) is defined by Expression (2) shown below. Specifically, the DecisionThreshold is (1−a)b if the IoTLevel=0, the DecisionThreshold is a(1−b) if the IoTLevel=1, and the DecisionThreshold is 1 if the IoTLevel=2. As defined in Expression (3) shown below, a recited in Expression (2) is a power level in a normalized range at the time of the previous transmission. In addition, as defined in Expression (4) shown below, b recited in Expression (2) is the current path loss level in a normalized range.

$$\begin{matrix}DecisionThreshold = \{ \begin{matrix}( 1 - a ) b & if IoTLevel = 0 \\ a ( 1 - b ) & if IoTLevel = 1 \\ 1 & if IoTLevel = 2\end{matrix} & ( 2 ) \\ a = \frac{{P}_{f} ( i - m ) - {P}_{f\_MIN}}{{P}_{f\_MAX} - {P}_{f\_MIN}} & ( 3 ) \\ b = \frac{min ( \begin{matrix}{PL}_{Strongest\_Neighbour} - \\ PL , {PL}_{DIFF\_MAX}\end{matrix} ) - {PL}_{DIFF\_MIN}}{{PL}_{DIFF\_MAX} - {PL}_{DIFF\_MIN}} & ( 4 )\end{matrix}$$

where P_{f}(i-m) is an expected power control value with respect to the (i-m)^{th} frame at the time of the previous transmission, and i-m is the time at which the previous power control was performed. P_{f}_{_{—}}_{MAX}, P_{f}_{_{—}}_{MIN}, PL_{DIFF}_{_{—}}_{MAX}, and PL_{DIFF}_{_{—}}_{MIN} are set parameters. PL is a path loss relevant to the connecting sector. PL_{Strongest}_{_{—}}_{Neighbour} is the minimum path loss among path losses relevant to the sectors other than the connecting sector.

The above-described scheme uses an IoT level for the entire band as interference information. However, a frequency band allocated to each mobile terminal is a part of the entire band. Therefore, depending on the allocated band, there is a possibility that the transmission power is controlled so as to be decreased (or increased) even though interference is small (or large). Such a control causes a problem in that the throughput is reduced. Moreover, power consumption is increased as a result of a reduction in throughput.

In addition, the transmission power of each mobile terminal is determined based on an IoT level supplied from the sector whose relevant path loss is the minimum among path losses relevant to the sectors other than a connecting sector. However, depending on a communication system (e.g., in the case of systems in accordance with the LTE), there is a possibility that the sector whose relevant path loss is the minimum among path losses relevant to the sectors other than a connecting sector cannot be determined. Nevertheless, such circumstances have not been taken into consideration. Furthermore, depending on a communication system (e.g., in the case of systems in accordance with the LTE), a problem may arise that the transmission power cannot be controlled due to difficulty in acquiring the minimum path loss among path losses relevant to the sectors other than a connecting sector.

### SUMMARY OF THE INVENTION

Accordingly, it is an object of the present invention is to provide a technique of controlling the transmission power of a mobile terminal that can improve the throughput and reduce power consumption. It is another object of the present invention is to provide a technique of controlling the transmission power of a mobile terminal that can improve the throughput and reduce power consumption even in communication systems that cannot determine the sector whose relevant path loss is the minimum among path losses relevant to the sectors other than a connecting sector as well as communication systems in which it is difficult to acquire the minimum path loss among path losses relevant to the sectors other than a connecting sector.

A first aspect of the present invention is a transmission power control apparatus which includes: an interference information acquisition unit which acquires interference information indicative of an interference amount for each frequency block in a neighboring base station; and a transmission power control unit which controls transmission power of a mobile terminal when a frequency block group configured by one or more frequency blocks is allocated to the mobile terminal, based on the interference information acquired by the interference information acquisition unit.

A second aspect of the present invention is a transmission power control method which includes: acquiring interference information indicative of an interference amount for each frequency block in a neighboring base station; and controlling transmission power of a mobile terminal when a frequency block group configured by one or more frequency blocks is allocated to the mobile terminal based on the acquired interference information.

A third aspect of the present invention is a computer-readable storage medium storing a program which makes a computer of a transmission power control apparatus that controls transmission power of a mobile terminal execute the steps of: acquiring interference information indicative of an interference amount for each frequency block in a neighboring base station; and controlling the transmission power of the mobile terminal when a frequency block group configured by one or more frequency blocks is allocated to the mobile terminal based on the acquired interference information.

In accordance with the foregoing aspects of the present invention, it is possible to improve the throughput and reduce power consumption. In particular, in accordance with the aspects of the present invention, the throughput can be improved and power consumption can be reduced even in communication systems that are unable to determine the sector whose relevant path loss is the minimum among path losses relevant to the sectors other than a connecting sector as well as in communication systems in which it is difficult to acquire the minimum path loss among path losses relevant to the sectors other than a connecting sector.

These and other objects, features, aspects, and advantages of the present invention will become apparent to those skilled in the art from the following detailed descriptions taken in conjunction with the accompanying drawings, illustrating the embodiments of the present invention.

### BRIEF DESCRIPTION OF THE DRAWINGS

FIG. 1 is a block diagram showing the structure of a transmission power control apparatus 1 according an embodiment of the present invention.

FIG. 2A is a schematic diagram illustrating the function of a power control interference amount acquisition unit 21.

FIG. 2B is another schematic diagram illustrating the function of the power control interference amount acquisition unit 21.

FIG. 3A is a flowchart showing an example of the operation of the transmission power control apparatus 1.

FIG. 3B is a flowchart showing another example of the operation of the transmission power control apparatus 1.

FIG. 4A is a schematic diagram illustrating the function of an interference information acquisition unit 10.

FIG. 4B is another schematic diagram illustrating the function of the interference information acquisition unit 10.

FIG. 5 is a block diagram showing the structure of a transmission power control apparatus la according to another embodiment of the present invention when there are a plurality of frequency block groups that are candidates for allocation.

FIG. 6 is a block diagram showing the structure of the transmission power control apparatus 1 according to the embodiment of the present invention along with an allocation determination apparatus 50 provided outside the transmission power control apparatus 1 when there are a plurality of frequency block groups that are candidates for allocation.

FIG. 7 is a block diagram showing the structure of a neighboring base station 60.

### DETAILED DESCRIPTION OF THE INVENTION

Hereinbelow, embodiments of the present invention will be described with reference to the accompanying drawings.

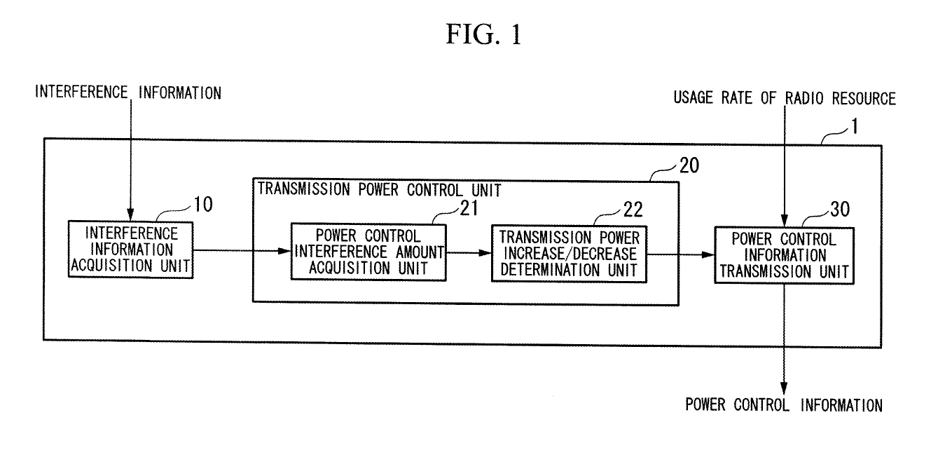

A transmission power control apparatus 1 according to an embodiment of the present invention is installed in, for example, a base station. As shown in FIG. 1, the transmission power control apparatus 1 is provided with an interference information acquisition unit 10, a transmission power control unit 20, and a power control information transmission unit 30. The transmission power control unit 20 is provided with a power control interference amount acquisition unit 21 and a transmission power increase/decrease determination unit 22.

The interference information acquisition unit 10 acquires interference information indicative of an interference amount for each frequency block. The interference information is generated by a neighboring base station. That is, the interference information acquisition unit 10 directly or indirectly acquires interference information generated by a neighboring base station from the neighboring base station. The interference information acquisition unit 10 supplies the acquired interference information to the transmission power control unit 20.

The transmission power control unit 20 acquires the interference information from the interference information acquisition unit 10. The transmission power control unit 20 controls the transmission power of a mobile terminal when a frequency block group configured by one or more frequency blocks (e.g., a frequency block group that is a candidate for allocation to the mobile terminal) is allocated to the mobile terminal, based on the interference information acquired from the interference information acquisition unit 10. To this end, the transmission power control unit 20 generates control information (hereinafter referred to as “power control information”) for controlling the transmission power when a mobile terminal transmits various pieces of information in the case in which a frequency block group (e.g., a frequency block group that is a candidate for allocation to the mobile terminal) is allocated to the mobile terminal The transmission power control unit 20 supplies the generated power control information to the power control information transmission unit 30. The details of the transmission power control unit 20 will be described later.

The power control information transmission unit 30 acquires the power control information from the transmission power control unit 20. The power control information transmission unit 30 also acquires radio resource usage rate information indicative of the usage rate of radio resources from the outside of the transmission power control apparatus 1. Upon receipt of the power control information from the transmission power control unit 20, the power control information transmission unit 30 transmits the received power control information to a mobile terminal in accordance with one of different formats depending on the usage rate of the radio resources indicated by the radio resource usage rate information. For example, if the usage rate of the radio resources is high, the power control information transmission unit 30 transmits the power control information as one bit of information. In contrast, if the usage rate of the radio resources is small, the power control information transmission unit 30 transmits the power control information as two bits of information. Upon receipt of the power control information from the power control information transmission unit 30, the mobile terminal controls the transmission power at the time of transmitting various pieces of information in accordance with the power control information. The formats used in transmitting the power control information to the mobile terminal will be described later.

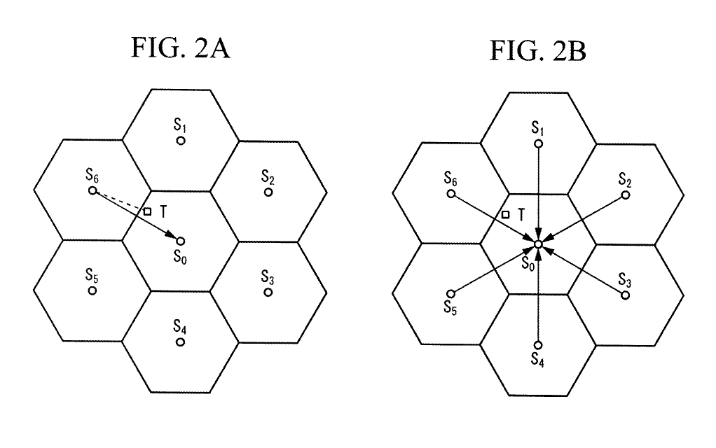

Subsequently, the transmission power control unit 20 will be described in greater detail. The power control interference amount acquisition unit 21 acquires an interference amount for a frequency block group in a neighboring base station (hereinafter referred to as “a maximum interference neighboring base station”) which provides a mobile terminal with the maximum interference amount among interference amounts provided by a plurality of neighboring base stations, from interference information of the maximum interference neighboring base station (i.e., interference information acquired from the maximum interference neighboring base station), as an interference amount which is referred to for controlling the transmission power (hereinafter referred to as “a power control interference amount”). An example of the maximum interference neighboring base station is a base station that is a candidate for hand-over by a mobile terminal In other words, the power control interference amount acquisition unit 21 acquires an interference amount of a frequency block group in a neighboring base station that is a candidate for hand-over by a mobile terminal among a plurality of neighboring base stations, from interference information of the neighboring base station that is a candidate for hand-over (interference information acquired from the neighboring base station that is a candidate for hand-over), as a power control interference amount. For example, as shown in FIG. 2A, if, among a plurality of neighboring base stations S₁ to S₆, which are adjacent to a base station S₀ in the area of which a mobile terminal T is present, a neighboring base station that is a candidate for hand-over by the mobile terminal T (the maximum interference neighboring base station) is the neighboring base station S₆, the power control interference amount acquisition unit 21 acquires (calculates) an interference amount of a frequency block group in the neighboring base station S₆ from interference information of the neighboring base station S₆ as a power control interference amount.

The power control interference amount acquisition unit 21 may acquire an average of interference amounts of frequency block groups in a plurality of neighboring base stations from interference information of the neighboring base stations (respective pieces of interference information acquired from the neighboring base stations), as a power control interference amount. For example, if the maximum interference neighboring base station (a neighboring base station that is a candidate for hand-over) related to a mobile terminal is unknown, the power control interference amount acquisition unit 21 acquires an average of interference amounts of frequency block groups in a plurality of neighboring base stations from interference information of the neighboring base stations, as a power control interference amount. For example, as shown in FIG. 2B, the power control interference amount acquisition unit 21 acquires (calculates) an average of interference amounts of frequency block groups in the neighboring base stations S₁ to S₆ from interference information of the neighboring base stations S₁ to S₆, as a power control interference amount. In FIG. 2A and FIG. 2B, arrows denote the acquisition of the interference information. Moreover, in FIG. 2A, the dotted line denotes a candidate for hand-over.

Having acquired the power control interference amount, the power control interference amount acquisition unit 21 supplies information indicative of the acquired power control interference amount (hereinafter referred to as “power control interference information”) to the transmission power increase/decrease determination unit 22.

The transmission power increase/decrease determination unit 22 acquires the power control interference information from the power control interference amount acquisition unit 21. The transmission power increase/decrease determination unit 22 determines whether to increase, decrease, or maintain the transmission power of a mobile terminal when a frequency block group is allocated to the mobile terminal, using the power control interference information acquired from the power control interference amount acquisition unit 21.

Specifically, in the case in which the power control interference amount acquisition unit 21 acquires a power control interference amount from interference information of the maximum interference neighboring base station (a neighboring base station that is a candidate for hand-over), the transmission power increase/decrease determination unit 22 determines to increase, decrease, or maintain the transmission power of a mobile terminal when a frequency block group is allocated to the mobile terminal, using the power control interference information acquired from the power control interference amount acquisition unit 21 (power control interference information indicative of the interference amount of a frequency block group in the maximum interference neighboring base station).

In contrast, in the case in which the power control interference amount acquisition unit 21 acquires power control interference amounts from interference information of a plurality of neighboring base stations, the transmission power increase/decrease determination unit 22 determines to increase, decrease, or maintain the transmission power of a mobile terminal when a frequency block group is allocated to the mobile terminal, using the power control interference information acquired from the power control interference amount acquisition unit 21 (power control interference information indicative of the average of interference amounts of frequency block groups in the neighboring base stations).

The transmission power increase/decrease determination unit 22 may determine whether to increase, decrease, or maintain the transmission power of a mobile terminal when a frequency block group is allocated to the mobile terminal using a random number in addition to the power control interference amount acquired by the power control interference amount acquisition unit 21. Specifically, upon receipt of the power control interference information (power control interference information indicative of an interference amount of a frequency block group in the maximum interference neighboring base station, or power control interference information indicative of the average of interference amounts of frequency block groups in a plurality of neighboring base stations) from the power control interference amount acquisition unit 21, the transmission power increase/decrease determination unit 22 may determine whether to increase, decrease, or maintain the transmission power of a mobile terminal when a frequency block group is allocated to the mobile terminal, using the power control interference information and a random number. If a determination whether to increase, decrease, or maintain the transmission power is made using only the power control interference amount, a great number of mobile terminals may increase or decrease their transmission power. In contrast, by restricting (limiting) the number of mobile terminals whose transmission power is increased or decreased using a random number, the possibility that a great number of mobile terminals increase or decrease their transmission power simultaneously is reduced, and hence stable power control can be realized.

Alternatively, the transmission power increase/decrease determination unit 22 may calculate the level of a path loss observed by a mobile terminal and determine whether to increase, decrease, or maintain the transmission power of the mobile terminal when a frequency block group is allocated to the mobile terminal, using the level of the path loss observed by the mobile terminal in addition to the power control interference amount acquired by the power control interference amount acquisition unit 21 (or in addition to the power control interference amount and the random number). Use of the level of a path loss makes it possible to realize a more effective power control. For example, the transmission power increase/decrease determination unit 22 generates a CDF (cumulative density function) distribution of path losses observed by the other mobile terminals, estimates a current path loss of the mobile terminal (a PL(u) described later), and calculates the level of a path loss of the mobile terminal (a path loss level coefficient X_{PL} described later) based on predetermined values in the CDF distribution (e.g., P_{PL}_{_{—}}ₘₐₓ and P_{PL}_{_{—}}ₘᵢₙ described later) and the current path loss.

If it is determined that the transmission power is to be increased, decreased, or maintained, the transmission power increase/decrease determination unit 22 generates power control information indicating that the transmission power is to be increased, decreased, or maintained. The transmission power increase/decrease determination unit 22 supplies the generated power control information to the power control information transmission unit 30.

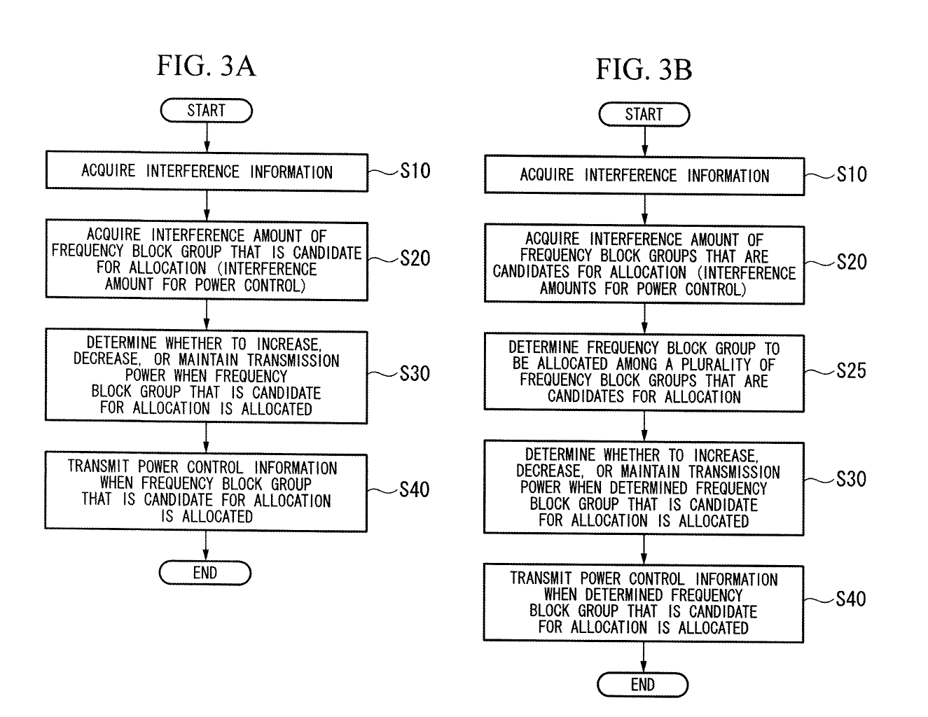

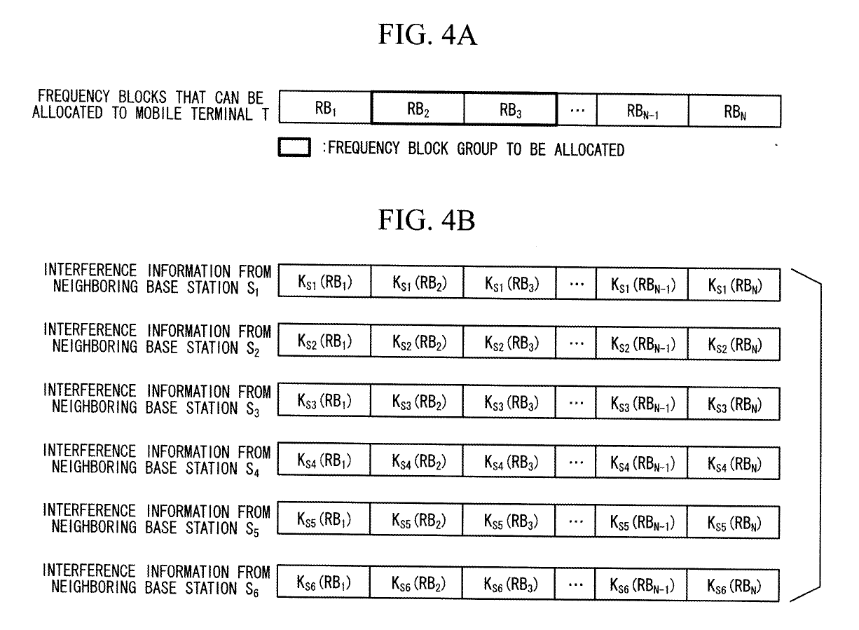

Hereinbelow, the operation of the transmission power control apparatus 1 will be described with reference to the flowchart shown in FIG. 3A. The following description assumes that the transmission power control apparatus 1 is installed in the base station S₀ shown in FIG. 2A and FIG. 2B, and the transmission power of the mobile terminal T, which is present in the area of the base station S₀, is controlled. The following description also assumes that N frequency blocks (RB₁, RB₂, . . . RB_{N-1}, and RB_{N}) shown in FIG. 4A, N being an integer greater than or equal to 3, can be allocated to the mobile terminal T, and a frequency block group that is a candidate for allocation is configured by two frequency blocks (e.g., RB₂ and RB₃).

The interference information acquisition unit 10 acquires interference information indicative of an interference amount for each frequency block (step S10). Specifically, as shown in FIG. 4B, the interference information acquisition unit 10 acquires interference information from respective neighboring base stations S₁ to S₆. The interference information acquisition unit 10 supplies the acquired interference information to the power control interference amount acquisition unit 21.

Upon receipt of the interference information of the respective neighboring base stations S₁ to S₆ from the interference information acquisition unit 10, the power control interference amount acquisition unit 21 acquires interference amounts of the frequency block group (RB₂ and RB₃) that is a candidate for allocation in the neighboring base station S₆ from the interference information of the base station S₆, which is a neighboring base station that is a candidate for hand-over, as a power control interference amount (step S20). For example, the power control interference amount acquisition unit 21 calculates an average of K_{S6} (RB₂), which is the interference amount related to RB₂ in the neighboring base station S₆, and K_{S6} (RB₃), which is the interference amount related to RB₃ in the neighboring base station S₆, as a power control interference amount.

If the neighboring base station that is a candidate for hand-over is unknown, in step S20, the power control interference amount acquisition unit 21 acquires interference amounts of the frequency block group (RB₂ and RB₃) that is a candidate for allocation in each of the neighboring base stations S₁ to S₆ from the interference information of the respective neighboring base stations S₁ to S₆, as a power control interference amount. For example, the power control interference amount acquisition unit 21 calculates averages K_{AVE}(RB₁) to K_{AVE}(RB_{N}) for RB₁ to RB_{N} in the respective neighboring base stations S₁ to S₆, and calculates an average ((K_{AVE}(RB₂)+K_{AVE}(RB₃))/2) of K_{AVE}(RB₂), which is an average of interference amounts related to RB₂ in the respective neighboring base stations S₁ to S₆, and K_{AVE}(RB₃), which is an average of interference amounts related to RB₃ in the respective neighboring base stations S₁ to S₆, as a power control interference amount. Alternatively, for example, the power control interference amount acquisition unit 21 may calculate an average of K_{S1}(RB₂), K_{S2}(RB₂), . . . , and K_{S6}(RB₂) and an average of K_{S1}(RB₃), K_{S2}(RB₃), . . . , and K_{S6}(RB₃), and then calculate an average of these two averages as a power control interference amount.

Upon receipt of the interference amounts of the frequency block group (RB₂ and RB₃) that is a candidate for allocation as power control interference amounts, the power control interference amount acquisition unit 21 supplies power control interference information indicative of the power control interference amounts to the transmission power increase/decrease determination unit 22.

Upon receipt of the power control interference information from the power control interference amount acquisition unit 21, the transmission power increase/decrease determination unit 22 determines whether to increase, decrease, or maintain the transmission power of the mobile terminal T when the frequency block group (RB₂ and RB₃) that is a candidate for allocation is allocated to the mobile terminal T, using the power control interference information and a random number (step S30).

In step S30, the transmission power increase/decrease determination unit 22 may determine whether to increase, decrease, or maintain the transmission power of the mobile terminal T when the frequency block group (RB₂ and RB₃) that is a candidate for allocation is allocated to the mobile terminal T, using the level of a path loss observed by the mobile terminal T in addition to the power control interference information and the random number.

Having determined that the transmission power is to be increased, decreased, or maintained, the transmission power increase/decrease determination unit 22 generates power control information indicating that the transmission power is to be increased, decreased, or maintained, and supplies the generated power control information to the power control information transmission unit 30.

Upon receipt of the power control information from the transmission power increase/decrease determination unit 22, the power control information transmission unit 30 transmits the power control information to the mobile terminal T in accordance with one of different formats depending on the usage rate of radio resources indicated by the radio resource usage rate information (step S40). The processing of the flowchart shown in FIG. 3A is then completed.

For the sake of convenience, the flowchart shown in FIG. 3A illustrates an example in which there is one frequency block group that is a candidate for allocation. In contrast, if there are a plurality of M frequency block groups that are candidates for allocation, M being an integer greater than or equal to 2, the transmission power control apparatus operates as shown in, for example, FIG. 3B.

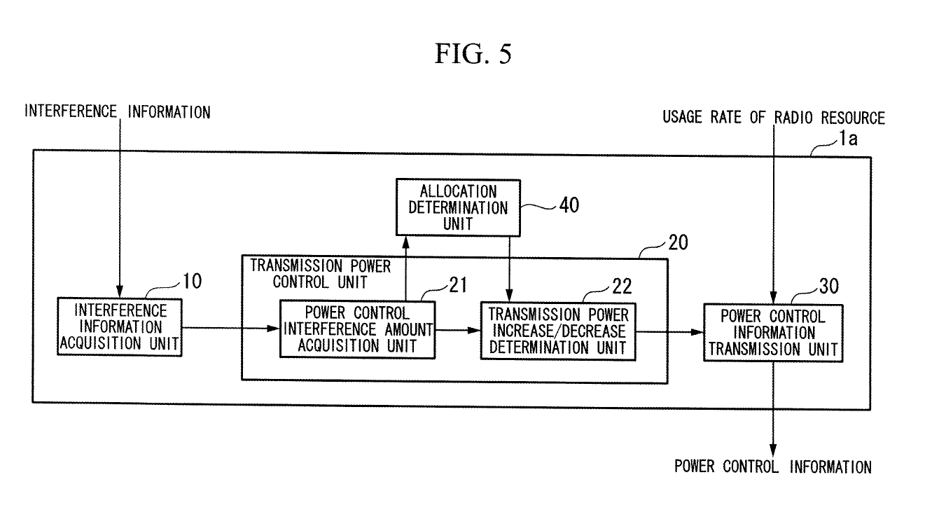

FIG. 5 is a block diagram showing the structure of a transmission power control apparatus la in this case. In FIG. 5, the same reference symbols as those shown in FIG. 1 are assigned to the same structural components as those shown in FIG. 1, and the description thereof is omitted. The transmission power control apparatus la is provided with an allocation determination unit 40 in addition to the structural components shown in FIG. 1.

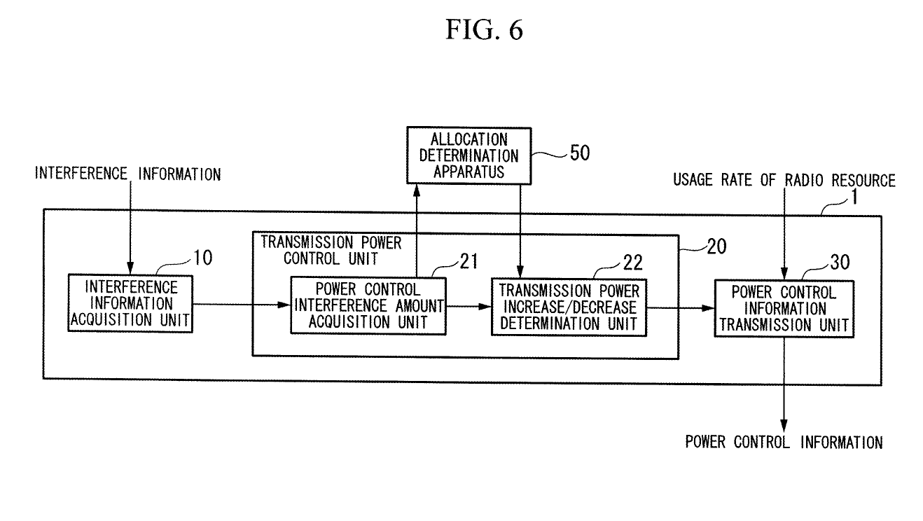

Alternatively, as shown in FIG. 6, instead of providing the allocation determination unit 40, an allocation determination apparatus 50 having the same function as that of the allocation determination unit 40 may be provided outside the transmission power control apparatus 1.

As shown in step S20 of FIG. 3B, the power control interference amount acquisition unit 21 acquires an interference amount of a frequency block group that is a first candidate for allocation in the neighboring base station S₆ (or the respective neighboring base stations S₁ to S₆) from interference information of the neighboring base station S₆ (or interference information of the respective neighboring base stations S₁ to S₆), as a power control interference amount related to the first candidate for allocation. In addition, the power control interference amount acquisition unit 21 acquires an interference amount of a frequency block group that is a second candidate for allocation in the neighboring base station S₆ (or the respective neighboring base stations S₁ to S₆) from interference information of the neighboring base station S₆ (or interference information of the respective neighboring base stations S₁ to S₆), as a power control interference amount related to the second candidate for allocation. With respect to power control interference amounts related to third to M^{th} candidates for allocation, the power control interference amount acquisition unit 21 operates in a similar manner. For example, the power control interference amount acquisition unit 21 acquires an interference amount of a frequency block group that is the M^{th} candidate for allocation of the neighboring base station S₆ (or the respective neighboring base stations S₁ to S₆) from interference information of the neighboring base station S₆ (or interference information of the respective neighboring base stations S₁ to S₆), as a power control interference amount related to the M^{th} candidate for allocation.

Once M power control interference amounts have been acquired, the power control interference amount acquisition unit 21 supplies power control interference information indicative of the respective power control interference amounts to the transmission power increase/decrease determination unit 22 and to the allocation determination unit 40 (or to the allocation determination apparatus 50).

The allocation determination unit 40 (or the allocation determination apparatus 50) determines a frequency block group to be allocated to the mobile terminal T from among the M frequency block groups that are the candidates for allocation (step S25). For example, the allocation determination unit 40 (or the allocation determination apparatus 50) refers to, for example, the M power control interference amounts acquired from the power control interference amount acquisition unit 21, and calculates communication quality (e.g., an SINR (a Signal to Interference plus Noise Ratio)) when the frequency block groups that are the candidates for allocation are allocated to the mobile terminal T. The allocation determination unit 40 (or the allocation determination apparatus 50) determines a frequency block group to be allocated to the mobile terminal T based on, for example, the communication quality in the case in which the frequency block groups that are the candidates for allocation are allocated to the mobile terminal T and the number of frequency blocks that configure respective frequency block groups (step S25). Once the frequency block group to be allocated to the mobile terminal T is determined, the allocation determination unit 40 (or the allocation determination apparatus 50) supplies information indicative of the determined frequency block group to the transmission power increase/decrease determination unit 22.

The transmission power increase/decrease determination unit 22 determines whether to increase, decrease, or maintain the transmission power of the mobile terminal T when the frequency block group that is a candidate for allocation determined by the allocation determination unit 40 (or the allocation determination apparatus 50) is allocated to the mobile terminal T, using the power control interference information and a random number (or the power control interference information, a random number, and the level of a path loss) (step S30).

Having determined that the transmission power is to be increased, decreased, or maintained, the transmission power increase/decrease determination unit 22 generates power control information indicating that the transmission power is to be increased, decreased, or maintained, and supplies the generated power control information to the power control information transmission unit 30.

Upon receipt of the supplied power control information, the power control information transmission unit 30 transmits the power control information to the mobile terminal T in accordance with one of different formats depending on the usage rate of radio resources indicated by the radio resource usage rate information (step S40). The processing of the flowchart shown in FIG. 3B is then completed.

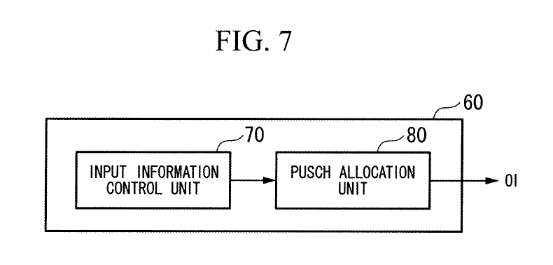

Hereinbelow, the respective operations of the transmission power control apparatus 1 (1a) will be described with reference to expressions. FIG. 7 is a block diagram showing the structure of a neighboring base station 60. In FIG. 7, only structural components related to the description below are shown among the structural components provided in the neighboring base station 60.

### Generation and Transmission of Interference Information

First, interference information to be acquired by the interference information acquisition unit 10 will be described. As shown in FIG. 7, the neighboring base station 60 is provided with an input information control unit 70 and a PUSCH (Physical Uplink Shared Channel) allocation unit 80. The PUSCH allocation unit 80 calculates an OI (an Overload Indicator) for each subframe. The input information control unit 70 supplies a transmission interval T_{OI} of the OI to the PUSCH allocation unit 80.

Specifically, the PUSCH allocation unit 80 measures interference I_{DMRS}(i,j) for a frequency block j (a PRB (a Physical Resource Block)ⱼ) and a subframe i using a DM-RS (a Demodulation Reference Signal), and calculates an IoT from interference Iₐᵥₑ_{_{—}}_{DMRS}(i,j), which is obtained by applying a statistical process (e.g., an averaging process) to the interference I_{DMRS}(i,j). The PUSCH allocation unit 80 sets Tₐᵥₑ to an average time interval Tₐᵥₑ_{_{—}}_{OI} acquired from the input information control unit 70.

Subsequently, in accordance with Expression (5) shown below, the PUSCH allocation unit 80 calculates an OI(s,j) using the calculated IoT as well as an IoTLevelTh1 and an IoTLevelTh2 acquired from the input information control unit 70. Here, s denotes a cell (a base station). In addition, the IoTLevelTh1 and the IoTLevelTh2 are thresholds used for determining the value of the OI(s,j).

If (IoT(j)<IoTLevelTh1) OI(s,j)=0

else if (IoT(j)<IoTLevelTh2) OI(s,j)=1

else OI(s,j)=2 (5)

The PUSCH allocation unit 80 transmits the calculated OI(s,j) at the transmission interval T_{OI} acquired from the input information control unit 70.

### Acquisition of a Power Control Interference Amount

The interference information acquisition unit 10 acquires OI(s,j) from neighboring base stations. In accordance with Expression (6) shown below, the power control interference amount acquisition unit 21 calculates an average (an OIₐᵥₑ(j)) of the OI(s,j) for respective sectors (the respective neighboring base stations) for each frequency block using the OI(s,j) acquired from the interference information acquisition unit 10.

$${OI}_{ave} ( j ) = \frac{1}{N} {\sum }_{NeighboringSector}^{N} OI ( s , j ) \qquad ( 6 )$$

The parameter NeighboringSector is defined as follows. If the mobile terminal has a cell (a neighboring base station) that is a candidate for hand-over, the NeighboringSector represents the cell that is a candidate for hand-over. In contrast, if the mobile terminal does not have a cell that is a candidate for hand-over, the NeighboringSector represents neighboring cells. The term “if the mobile terminal has a cell that is a candidate for hand-over” means that a measurement report has been received in a period corresponding to a notification interval in which the measurement report is to be notified from a neighboring base station. Similarly, the term “if the mobile terminal does not have a cell that is a candidate for hand-over” means that no measurement report has been received in the period corresponding to the notification interval. In addition, N denotes the number of cells represented by the NeighboringSector.

Subsequently, in accordance with Expression (7) shown below, the power control interference amount acquisition unit 21 calculates a power control interference amount (IoTLevel(J)) which is an average of OIₐᵥₑ(j) with respect to PRBⱼ that is a candidate for allocation to the mobile terminal based on the OIₐᵥₑ(j), where each OIₐᵥₑ(j) is an average of the OI(s,j) for each PRB.

$$IoTLevel ( J ) = \frac{1}{{J}^{′}} {\sum }^{J} {OI}_{ave} ( j ) , \qquad ( 7 )$$

where J is a set of candidates for allocation PRBs, and J′ is the number of PRBs that constitute the set J of the candidates for allocation PRBs.

### Calculation of a Transmission Power Fluctuation Level Coefficient

In the case in which a determination whether to increase, decrease, or maintain the transmission power is made using a transmission power fluctuation level coefficient X_{txpower}, in accordance with Expression (8) shown below, the transmission power increase/decrease determination unit 22 calculates, for each mobile terminal, the transmission power fluctuation level coefficient X_{txpower} that is dependent on a cumulative transmission power level Pₜₓ_{_{—}}_{assign}(u). Pₜₓ_{_{—}}ₘₐₓ and Pₜₓ_{_{—}}ₘᵢₙ respectively denote an upper limit and a lower limit of a transmission power fluctuation level acquired from the outside (a neighboring base station). Moreover, u denotes a mobile terminal.

$${X}_{txpower} = \frac{{P}_{tx\_max} - {P}_{tx\_assign} ( u )}{{P}_{tx\_max} - {P}_{tx\_min}} \qquad ( 8 )$$

### Calculation of a Path Loss Level Coefficient

In the case in which a determination whether to increase, decrease, or maintain the transmission power is made using the level of a path loss relevant to a mobile terminal, the transmission power increase/decrease determination unit 22 calculates a path loss level coefficient X_{PL} corresponding to an estimated path loss value PL(u) for each mobile terminal in accordance with Expression (9) and Expression (10) shown below. P_{PL}_{_{—}}ₘₐₓ and P_{PL}_{_{—}}ₘᵢₙ denote path losses which respectively correspond to the values at X_{PL}_{_{—}}ₘₐₓ % and X_{PL}_{_{—}}ₘᵢₙ % in a CDF distribution, which is generated from average path losses for respective mobile terminals calculated at a path loss average time interval Tₐᵥₑ_{_{—}}_{PL}, which is acquired from the outside (a neighboring base station). The aggregation time used in generating the CDF distribution for transmission power control as well as X_{PL}_{_{—}}ₘₐₓ and X_{PL}_{_{—}}ₘᵢₙ are acquired from the outside (a neighboring base station).

$$\begin{matrix}\begin{matrix}If ( PL ( u ) > {P}_{PL\_max} ) & PL ( u ) = {P}_{PL\_max} \\ else if ( PL ( u ) < {P}_{PL\_min} ) & PL ( u ) = {P}_{PL\_min} \\ else & PL ( u ) = PL ( u )\end{matrix} & ( 9 ) \\ {X}_{PL} = \frac{{P}_{PL\_max} - PL ( u )}{{P}_{PL\_max} - {P}_{PL\_min}} & ( 10 )\end{matrix}$$

### Determination Whether to Increase, Decrease, or Maintain the Transmission Power

The transmission power increase/decrease determination unit 22 determines whether to increase, decrease, or maintain the transmission power in accordance with Expressions (11) to (13) shown below. Specifically, the transmission power increase/decrease determination unit 22 increases the transmission power when δ_{PUSCH}(i)=1, it decreases the transmission power when δ_{PUSCH}(i)=−1, and it maintains the current transmission power when δ_{PUSCH}(i)=0.

If (IoTLevel(J)>1) δ′_{PUSCH}(i)=−1

else if (IoTLevel(J)≦0.5) and (IoTLevel(J)≦x) δ′_{PUSCH}(i)=+1

else if (IoTLevel(J)>0.5) and (IoTLevel(J)>x) δ′_{PUSCH}(i)=−1

else δ′_{PUSCH}(i)=0 (11)

where x is a uniform random number in the range from 0 to 1. The value of the random number is determined once for each mobile terminal and for each subframe. In the case of the DCI (Digital Cinema Initiatives) format 0 and the DCI format 3:

If (Pₜₓ_{_{—}}_{assign}(u)>Pₜₓ_{_{—}}ₘₐₓ) δ_{PUSCH}(i)=0 and Pₜₓ_{_{—}}_{assign}(u)=Pₜₓ_{_{—}}ₘₐₓ

else if (Pₜₓ_{_{—}}_{assign}(u)<Pₜₓ_{_{—}}ₘᵢₙ) δ_{PUSCH}(i)=0 and Pₜₓ_{_{—}}_{assign}(u)=Pₜₓ_{_{—}}ₘᵢₙ

else δ_{PUSCH}(i)=δ′_{PUSCH}(i) and P_{tx assign}(u)=P_{tx assign}(u) (12)

In the case of the DCI format 3A:

If (Pₜₓ_{_{—}}_{assign}(u)>Pₜₓ_{_{—}}_{max) δ}_{PUSCH}(i)=−1 and Pₜₓ_{_{—}}_{assign}(u)=Pₜₓ_{_{—}}ₘₐₓ−1

else if (Pₜₓ_{_{—}}_{assign}(u)<Pₜₓ_{_{—}}_{min) δ}_{PUSCH}(i)=+1 and P_{tx assign}(u)=P_{tx min}+1

else if (δ′_{PUSCH}(i)≠0) δ_{PUSCH}(i)=δ′_{PUSCH}(i) and Pₜₓ_{_{—}}_{assign}(u)=Pₜₓ_{_{—}}_{assign}(u)

else if (y<0.5) δ_{PUSCH}(i)=−1 and Pₜₓ_{_{—}}_{assign}(u)=Pₜₓ_{_{—}}_{assign}(u)−1

else δ_{PUSCH}(i)=+1 and Pₜₓ_{_{—}}_{assign}(u)=Pₜₓ_{_{—}}_{assign}(u)+1 (13)

where y is a uniform random number in the range from 0 to 1. The value of the random number is determined once for each mobile terminal and for each subframe.

The transmission power increase/decrease determination unit 22 may use Expression (14) shown below instead of Expression (11). aᵤₚ and a_{down} are weighting coefficients. That is, the transmission power increase/decrease determination unit 22 determines whether to increase, decrease, or maintain the transmission power based on indices obtained by weighting average interference information. In Expression (14), exponential weights are multiplied; however, linear weights may be multiplied.

$$\begin{matrix}If ( IoTLevel ( J ) > 1 ) & {δ}_{PUSCH}^{′} ( i ) = - 1 \\ else if \{ ( IoTLevel ( J ) \leq 0.5 ) and ( \frac{{( IoTLevel ( J ) )}^{{α}_{up}}}{{0.5}^{( {α}_{up} - 1 )}} \leq x ) \} & {δ}_{PUSCH}^{′} ( i ) = + 1 \\ else if \{ ( IoTLevel ( J ) > 0.5 ) and ( 1 - \frac{{( 1 - IoTLevel ( J ) )}^{{α}_{down}}}{{0.5}^{( {α}_{down} - 1 )}} > x ) \} & {δ}_{PUSCH}^{′} ( i ) = - 1 \\ else & {δ}_{PUSCH}^{′} ( i ) = 0\end{matrix} \qquad ( 14 )$$

The transmission power increase/decrease determination unit 22 may use Expression (15) shown below, instead of Expression (11) and Expression (14). That is, the transmission power increase/decrease determination unit 22 determines whether to increase, decrease, or maintain the transmission power using path loss information relevant to a cell of a base station, which is held in the base station.

If (IoTLevel(J)>1) δ′_{PUSCH}(i)=−1

else if {(IoTLevel(J)≦0.5) and (X_{PL}·(1−X_{txpower})≧x)} δ′_{PUSCH}(i)=+1

else if {(IoTLevel(J)>0.5) and ((1−X_{PL})·X_{txpower}≧x)} δ′_{PUSCH}(i)=−1 (15)

else δ′_{PUSCH}(i)=0

In Expression (15), X_{txpower} denotes a transmission power fluctuation level coefficient related to a mobile terminal for which whether to increase, decrease, or maintain the transmission power is to be determined, and it is calculated by Expression (8). Weighting as shown in Expression (14) may be employed. X_{PL} is the level of a path loss related to the mobile terminal for which whether to increase, decrease, or maintain the transmission power is to be determined, and it is calculated by Expression (10).

Which one of Expressions (11), (14), and (15) is used in calculating δ_{PUSCH}(i) can be designated by F_{UL}_{_{—}}_{TPC}. The interference information acquisition unit 10 or the power control information transmission unit 30 acquires the F_{UL}_{_{—}}_{TPC} from the outside (a neighboring base station).

With respect to the mobile terminal for which whether to increase, decrease, or maintain the transmission power is to be determined, if there is no difference between the OI at the time of the previous allocation and the OI related to the current subframe and if allocation is made to the same PRB as that at the time of the previous allocation, δ′_{PUSCH}(i) is set to 0 and δ_{PUSCH}(i) is calculated from Expression (16) shown below and Expressions (12) and (13).

Pₜₓ_{_{—}}_{assign}(u)=Pₜₓ_{_{—}}_{assign}(u)+δ′_{PUSCH}(i) (16)

In contrast, with respect to the mobile terminal for which whether to increase, decrease, or maintain the transmission power is to be determined, if there is a difference between the OI at the time of the previous allocation and the OI related to the current subframe or if allocation is made to a PRB different from that at the time of the previous allocation, δ_{PUSCH}(i) is calculated by Expressions (14) and (13).

The above-described DCI format 3 and DCI format 3A are used for a packet that is transmitted first in accordance with the semi-persistent scheduling. In contrast, the DCI format 0 is used for packets other than the packet that is transmitted first in accordance with the semi-persistent scheduling. The transmission power for the packet that is transmitted first in accordance with the semi-persistent scheduling is controlled by, for example, a DCI format 3/3A transmission interval T_{format3}. The interference information acquisition unit 10 or the power control information transmission unit 30 acquires the transmission interval T_{format3} from the outside (a neighboring base station). Transmission in accordance with the DCI format 3 and transmission in accordance with the DCI format 3A are performed in accordance with CCE (Control Channel Element) allocation success/failure information supplied from a CCH (Control Channel) allocator provided in the power control information transmission unit 30. If there are a plurality of DCI formats 3/3A, the DCI formats 3/3A are output to the CCH allocator in the order of the number of mobile terminals that satisfy δ_{PUSCH}(i)≠0 in Expression (15) (i.e., the DCI format 3/3A corresponding to the largest number of mobile terminals is output first and the DCI format 3/3A corresponding to the smallest number of mobile terminals is output last). Whether the DCI format 3 is used or the DCI format 3A is used is switched on a per cell basis in accordance with the condition defined by following Expression (17).

$$\begin{matrix}If ( \frac{{\sum }_{k = i - {N}_{T\_format 3} - 1}^{i - 1} {N}_{j\_used} ( k )}{{N}_{j} \times {N}_{T\_format 3}} \leq {th}_{usage\_format 3} ) & use DCI format 3 \\ else & use DCI format 3 A\end{matrix} \qquad ( 17 )$$

In Expression (17), Nⱼ denotes the total number of PRBs included in the band of a system, which is acquired from the outside, N_{T}_{_{—}}_{format3} denotes the number of subframes in a section in which PRB load rates are averaged, which is acquired from the outside, Nⱼ_{_{—}}_{used}(k) denotes the number of used PRBs in a subframe k, and th_{usage}_{_{—}}_{format3} denotes a threshold acquired from the outside.

With the above-described transmission power control apparatus 1 (1a), the throughput can be improved and power consumption can be reduced. In particular, it is possible to improve the throughput and reduce power consumption even in communication systems which are unable to determine the sector whose relevant path loss is the minimum among path losses relevant to the sectors other than a connecting sector as well as in communication systems in which it is difficult to acquire the minimum path loss among path losses relevant to the sectors other than a connecting sector. More specifically, in accordance with the transmission power control apparatus 1 (1a), it is possible to determine whether to increase, decrease, or maintain the transmission power from average interference information related to a frequency block that is a candidate for allocation, thereby contributing to improvement in throughput. In addition, it is possible to control the transmission power even if it is impossible to determine the sector whose relevant path loss is the minimum among path losses relevant to the sectors other than a connecting sector or even if it is impossible to acquire a path loss relevant to an interference sector. The IoT level may be a value indicative of the magnitude of interference such as 0, 1, or 2. Alternatively, the IoT level may be a ratio of interference to noise (IoT).

The respective processes of the transmission power control apparatus 1 (1a) according to the embodiments of the present invention may be performed by: storing a program for executing the respective processes of the transmission power control apparatus 1 (1a) on a computer-readable storage medium; reading the program stored in the storage medium in a computer system; and executing the program by the computer system. The computer system referred to here may include an OS (Operating System) and hardware such as peripheral devices. The computer system also encompasses environments for presenting and/or displaying home pages if a WWW (a World Wide Web) system is used.

The computer-readable storage medium refers to a flexible disk, a magneto-optical disk, a ROM (a Read Only Memory), a writable non-volatile memory such as a flash memory, a portable medium such as a CD (Compact Disc)-ROM, or a storage apparatus such as a hard disk built in a computer system.

The computer-readable storage medium also includes a medium that retains the program for a certain period of time, such as a volatile memory (e.g., a DRAM (Dynamic Random Access Memory)) in a computer system which functions as a server or a client when the program is transferred through a network such as the Internet and/or a communication line such as a telephone line.

The program may be transferred from a computer system having a storage apparatus or the like that stores the program to another computer system through a transmission medium or by a transmission wave in a transmission medium. Here, the “transmission medium” transferring the program refers to a medium having a function of transferring information, like a network such as the Internet or a communication line such as a telephone line. The program may realize a part of the foregoing functions. The program may be a so-called differential file (a differential program) which is capable of realizing the foregoing functions in combination with a program already stored in a computer system.

While preferred embodiments of the present invention have been described and illustrated above, it should be understood that these are exemplary of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the appended claims.

What is claimed is:

1. A transmission power control apparatus comprising:
an interference information acquisition unit which acquires interference information indicative of an interference amount for each frequency block in a neighboring base station; and
a transmission power control unit which controls transmission power of a mobile terminal when a frequency block group configured by one or more frequency blocks is allocated to the mobile terminal, based on the interference information acquired by the interference information acquisition unit.

2. The transmission power control apparatus according to claim 1, wherein the transmission power control unit comprises:
a power control interference amount acquisition unit which acquires an interference amount for the frequency block group in a maximum interference neighboring base station, the interference amount provided to the mobile terminal by the maximum interference neighboring base station being the maximum among interference amounts provided to the mobile terminal by a plurality of neighboring base stations, from interference information of the maximum interference neighboring base station, as a power control interference amount which is an interference amount for controlling the transmission power; and
a transmission power increase/decrease determination unit which determines whether to increase, decrease, or maintain the transmission power of the mobile terminal when the frequency block group is allocated to the mobile terminal, using the power control interference amount acquired by the power control interference amount acquisition unit.

3. The transmission power control apparatus according to claim 2, wherein the transmission power increase/decrease determination unit determines whether to increase, decrease, or maintain the transmission power using a random number in addition to the power control interference amount acquired by the power control interference amount acquisition unit.

4. The transmission power control apparatus according to claim 2, wherein the transmission power increase/decrease determination unit calculates a level of a path loss relevant to the mobile terminal, and determines whether to increase, decrease, or maintain the transmission power using the level of the path loss in addition to the power control interference amount acquired by the power control interference amount acquisition unit.

5. The transmission power control apparatus according to claim 4, wherein the transmission power increase/decrease determination unit generates a cumulative density function distribution of path losses relevant to other mobile terminals, estimates a current path loss relevant to the mobile terminal, and calculates the level of the path loss relevant to the mobile terminal based on a predetermined value in the cumulative density function distribution and the current path loss.

6. The transmission power control apparatus according to claim 1, wherein the transmission power control unit comprises:
a power control interference amount acquisition unit which acquires an average interference amount for the frequency block group in a plurality of neighboring base stations from interference information of the neighboring base stations, as a power control interference amount which is an interference amount for controlling the transmission power; and
a transmission power increase/decrease determination unit which determines whether to increase, decrease, or maintain the transmission power of the mobile terminal when the frequency block group is allocated to the mobile terminal, using the power control interference amount acquired by the power control interference amount acquisition unit.

7. The transmission power control apparatus according to claim 6, wherein the transmission power increase/decrease determination unit determines whether to increase, decrease, or maintain the transmission power using a random number in addition to the power control interference amount acquired by the power control interference amount acquisition unit.

8. The transmission power control apparatus according to claim 6, wherein the transmission power increase/decrease determination unit calculates a level of a path loss relevant to the mobile terminal, and determines whether to increase, decrease, or maintain the transmission power using the level of the path loss in addition to the power control interference amount acquired by the power control interference amount acquisition unit.

9. The transmission power control apparatus according to claim 8, wherein the transmission power increase/decrease determination unit generates a cumulative density function distribution of path losses relevant to other mobile terminals, estimates a current path loss relevant to the mobile terminal, and calculates the level of the path loss relevant to the mobile terminal based on a predetermined value in the cumulative density function distribution and the current path loss.

10. The transmission power control apparatus according to claim 1, wherein the transmission power control unit generates information for controlling the transmission power, and
the transmission power control apparatus further comprises a power control information transmission unit which transmits the information for controlling the transmission power to the mobile terminal in accordance with one of different formats depending on a usage rate of a radio resource.

11. The transmission power control apparatus according to claim 2, wherein the maximum interference neighboring base station is a neighboring base station which is a candidate for hand-over by the mobile terminal

12. The transmission power control apparatus according to claim 6, wherein the power control interference amount acquisition unit acquires the average interference amount when a maximum interference neighboring base station is unknown, an interference amount provided to the mobile terminal by the maximum interference neighboring base station being the maximum among interference amounts provided to the mobile terminal by a plurality of neighboring base stations.

13. The transmission power control apparatus according to claim 3, wherein the number of mobile terminals whose transmission power is increased or decreased is restricted by using the random number.

14. The transmission power control apparatus according to claim 7, wherein the number of mobile terminals whose transmission power is increased or decreased is restricted by using the random number.

15. The transmission power control apparatus according to claim 1, further comprising an allocation determination unit which determines the frequency block group to be allocated to the mobile terminal from among a plurality of frequency block groups which are candidates for allocation.

16. The transmission power control apparatus according to claim 15, wherein the allocation determination unit determines the frequency block group based on communication quality when each of the frequency blocks which are the candidates for allocation is allocated to the mobile terminal and the number of frequency blocks that configure each frequency block group.

17. A transmission power control method comprising:
acquiring interference information indicative of an interference amount for each frequency block in a neighboring base station; and
controlling transmission power of a mobile terminal when a frequency block group configured by one or more frequency blocks is allocated to the mobile terminal based on the acquired interference information.

18. A computer-readable storage medium storing a program which makes a computer of a transmission power control apparatus that controls transmission power of a mobile terminal execute the steps of:
acquiring interference information indicative of an interference amount for each frequency block in a neighboring base station; and
controlling the transmission power of the mobile terminal when a frequency block group configured by one or more frequency blocks is allocated to the mobile terminal based on the acquired interference information.
